(19) United States
(12) Patent Application Publication
(10) Pub. No.: US 2013/0346157 A1
(43) Pub. Date: Dec. 26, 2013

(54) REVENUE OPTIMIZATION PLATFORM APPARATUSES, METHODS, SYSTEMS AND SERVICES

(71) Applicants: Dionysios AVRILIONIS, Hesperange (LU); Panagiotis KONSTANTINIDIS, Hesperange (LU)

(72) Inventors: Dionysios AVRILIONIS, Hesperange (LU); Panagiotis KONSTANTINIDIS, Hesperange (LU)

(21) Appl. No.: 13/923,119

(22) Filed: Jun. 20, 2013

Related U.S. Application Data
(60) Provisional application No. 61/661,880, filed on Jun. 20, 2012.

(51) Int. Cl. G06Q 30/02

(52) U.S. Cl. CPC G06Q 30/0206
USPC 705/7.35

(57) ABSTRACT

The revenue optimization platform apparatuses, methods, systems and services (“ROP”) implement revenue optimization algorithms to transform event data via ROP components into product optimal prices, purchasing probabilities at suggested sales prices, revenue leakage and revenue potential calculations. The ROP components can be deployed in centralized or distributed systems, either physical or virtualized. The ROP functionality can be intuitively used through graphical user interfaces accompanying the ROP or through APIs, which will be used to interface with the ROP Service through the appropriate functions. The ROP hides the complexity of the revenue optimization calculations and provides an easy-to-use, flexible means of implementing revenue optimization in numerous real life situations.

### CROSS-REFERENCE TO RELATED APPLICATIONS

This application claims the benefit of U.S. Provisional Application No. 61/661,880, filed on 20 Jun. 2012. The entire disclosure of the above application is incorporated herein by reference.

### FIELD

This application for letters patent discloses and describes various novel innovations and inventive aspects of Revenue Optimization Platform technology (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

The present innovations generally address apparatuses, methods, systems and services for sales event control, and more particularly, include Revenue Optimization Platform Apparatuses, methods, systems and services (“ROP”)

### BACKGROUND

Corporations may launch sales event to promote their products, including both tangible and intangible products. Services may be a form of intangible products. Corporations may conduct analysis to learn about potential market of their products and collect information such as consumer preferences in their purchasing history and competitor products. For another example, corporations may hire sales representatives to manage and implement sales events.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIG. 1A provides an exemplary block diagram illustrating aspects of the ROP providing sales analysis to a sales representative within embodiments of the ROP. In this exemplary embodiment the ROP client runs on a mobile device;

FIGS. 1B-1C provide an exemplary block diagram illustrating aspects of price-oriented customer clustering within alternative embodiments of the ROP;

FIG. 2 provides a data flow diagram illustrating exemplary data flows between the ROP and its affiliated entities within embodiments of the ROP;

FIGS. 3A-3C provide exemplary logic flow diagrams illustrating ROP sales prediction analysis within embodiments of the ROP;

FIG. 4A provides a block diagram illustrating a ROP client component running on a mobile device, within embodiments of the ROP;

FIGS. 4B-4E provide block diagrams illustrating exemplary ROP deployment options within embodiments of the ROP;

FIG. 5A-5B provide exemplary mobile component user interfaces illustrating ROP mobile component data output within embodiments of the ROP;

FIGS. 6A-6B provide exemplary web-based user interfaces illustrating data output within alternative embodiments of the ROP client running on a desktop or laptop computer; and

FIG. 7 shows a block diagram illustrating example aspects of a ROP controller.

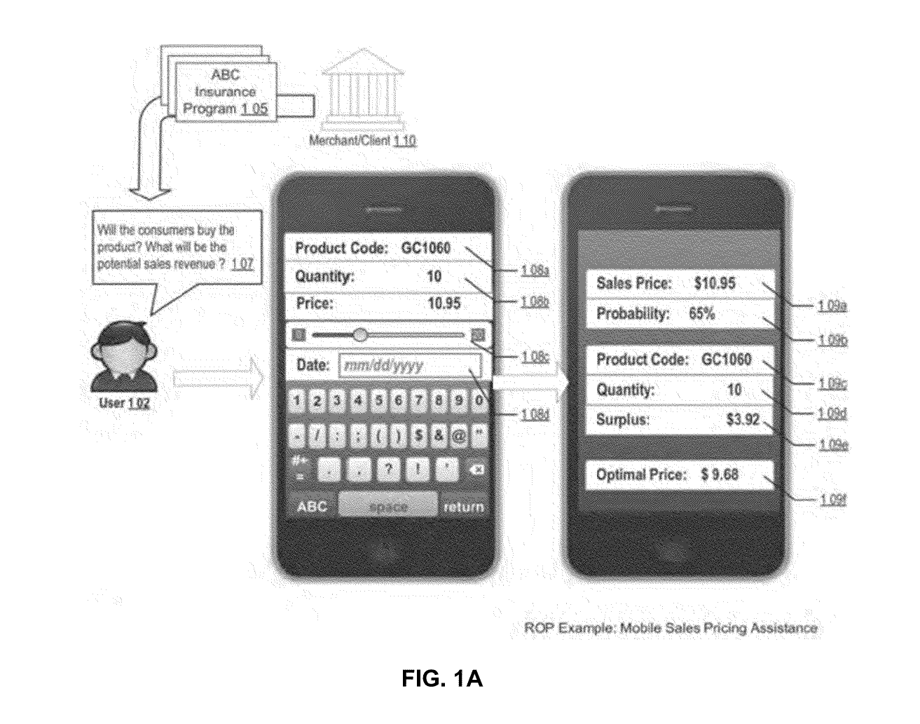

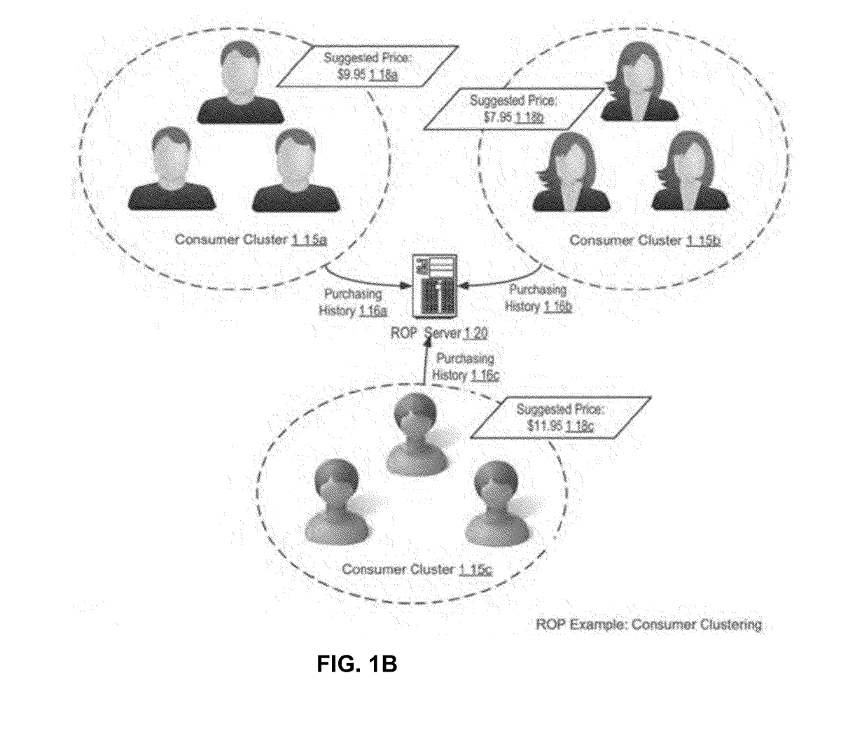

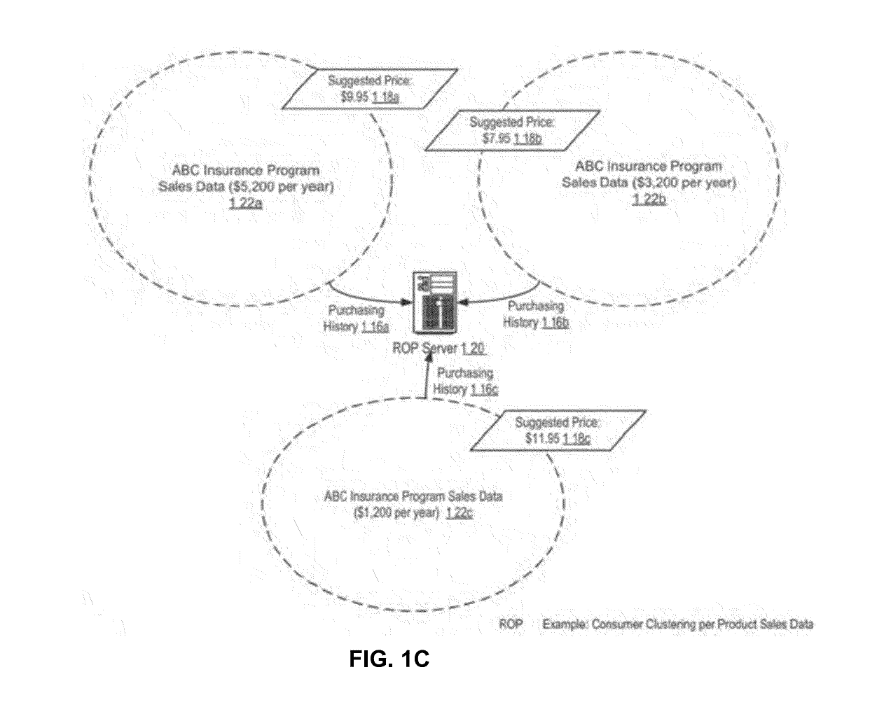

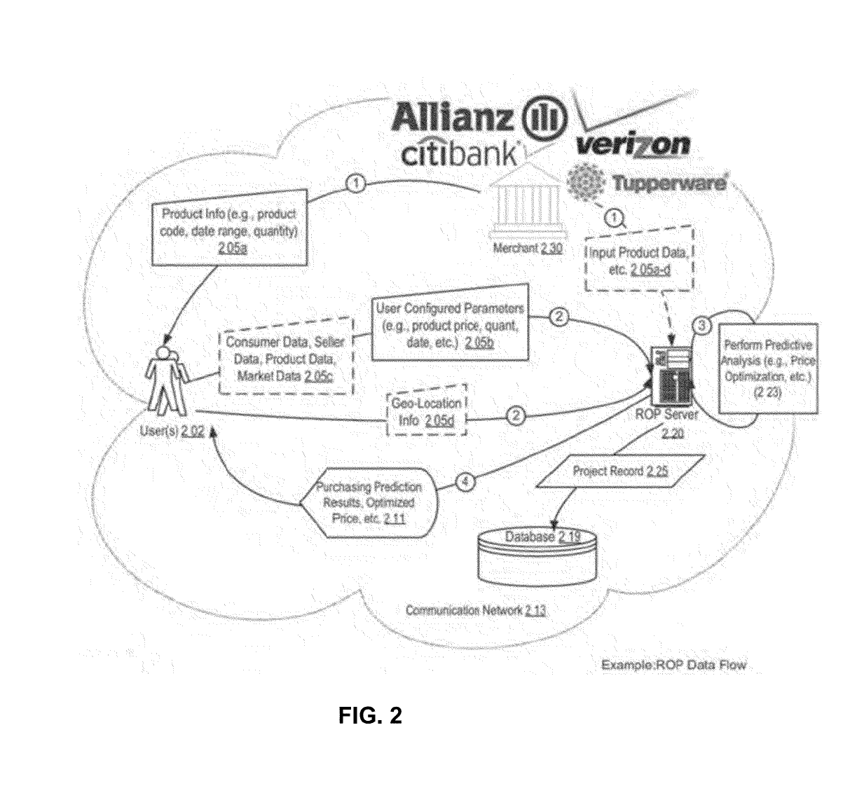

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Revenue Optimization Platform (ROP)

The revenue optimization platform apparatuses, methods, systems and services (hereinafter “ROP”) transform sales event data, via ROP components, into customer purchasing probability, suggested optimal prices and revenue surplus. The ROP leverages business-to-business and business-to-customer sales event, to support strategic decision-making of corporate executives with respect to optimally pricing or re-pricing products to maximize revenue from all sales events, as well as tactical decision-making of sales people for providing the right price that will maximize the revenue from each prospective sales event. The ROP is powered by technological apparatuses, including computer systems, local and distributed physical and virtual platforms, and mobile devices such as mobile phones and tablets. The Revenue Optimization Platform Apparatuses, methods, systems and services (“ROP”), which may also be referred to herein as MARKET PREDICTION CONTROL PLATFORM APPARATUSES, METHODS AND SYSTEMS (“MPCP”).

For example, in one implementation, the ROP can be instantiated on a user-operated mobile device comprising a sales prediction and sales revenue optimization mobile component. The mobile device can be a mobile phone, a smart phone, a personal digital assistant (PDA), a tablet computer, a laptop computer, and/or the like, operated by a sales representative, who may interact with the component via a graphic a user interface operably installed on the user-operated mobile device. The user will be able to configure sales event parameters and obtain sales event simulation results. For example, the user (e.g., a sales representative) may be able to configure the sales price of a product, which he wishes to quote to his customer, and obtain the probability of success (sales probability) and the revenue surplus (extra revenue) at the obtained suggested price, supposing that the subject method also relates to a sales prediction processor-implemented method, comprising: instantiating a sales prediction mobile component at a user operated mobile device; obtaining an input dataset including a user configured sales price of a product via a user interface of the sales prediction mobile component; processing the obtained input dataset to test quality of the input data; performing price optimization based on a non-linear optimization procedure that maximizes a sales revenue; obtaining a suggested price from the non-linear optimization; and presenting the obtained suggested price via a graphic user interface of the sales prediction mobile component.

Product will indeed be sold at the given sales price. For another example, the sales user may request an optimal price analysis via the user interface of the ROP component, which may in turn provide a suggested optimal price for the product. In both examples, the user will quickly and intuitively enjoy the benefits from the ROP system implementing some or all of the steps of the ROP method, overcoming the complexity of the revenue maximization calculations.

In one implementation, in case the ROP client is a typical computer of a user, the ROP system may comprise a database where past sales data may be stored or acquired, a module for processing input sales data such as performing data segmentation, a module on the ROP computer server for price optimization calculations with the objective of revenue maximization, a module for supplying the ROP system results through a graphical user interface to the computer system of the user.

In another implementation, in case the ROP client is a mobile device and not a typical computer of a user, the ROP system may comprise a database where past sales data may be stored or acquired, a module for processing input sales data such as performing data segmentation, a module for transferring data to the mobile device, a module running on the mobile device for price optimization calculations with the objective of revenue maximization, a module for supplying the price optimization and revenue maximization results through a graphical user interface to the mobile device of the user.

In an exemplary embodiment, the ROP system may implement the method whereby the revenue leakage is calculated, according to which as revenue leakage of a product is defined as the difference between the revenue that could have been attained if all sales events of a product had taken place at the optimal price, and the revenue that was actually attained through the various sales event of the same product, which was sold at various sales prices (different from the optimal price). By accumulating the revenue leakage of all products in a certain time period, the total revenue leakage for the company is calculated for the same time period. The revenue leakage calculation is very beneficial for the strategic decision-making of a company, as it uncovers and quantifies the revenue that a company has been leaking due to suboptimal sales tactics.

In an another exemplary embodiment, the ROP system may implement the method whereby the revenue potential is calculated, according to which as revenue potential of a product is defined the cumulative revenue for the company that can potentially be attained by adding the revenue from all customers, who have a high propensity (or a propensity above a certain threshold) of buying the specific product. It is assumed that such sales events will take place at the optimal price of the product, as calculated by the ROP. By accumulating the revenue potential of all products in a certain time period, the total revenue potential for the company is calculated for the same time period. The revenue potential calculation is very beneficial for the strategic decision-making of a company, such as the definition of future sales targets, as it uncovers and quantifies the revenue that a company can potentially attain per product, by selling each product to the right customers.

FIG. 1A provides an exemplary block diagram illustrating aspects of the ROP providing sales analysis to a sales representative within embodiments of the ROP. In one implementation, a merchant 110, e.g., a manufacturer, a product distributor, a brand name product producer, etc., may desire to promote their products, e.g., ABC insurance program 105, etc., in the market by launching a sales event. In one implementation, a ROP user (e.g., a sales representative, a sales manager, etc.) 102 may prepare a prospective sales event (a quote) to be communicated to the prospective customer. In order to take the best decision about which product 105 price to offer to the prospective customer, the user 102 may take into account the revenue optimization analysis results, including the optimal price 109f, the probability 109b of successfully closing the deal at the sales price 109a, which the user wants to quote, as well as the revenue surplus 109e from the prospective sales event.

For example, in one implementation, a user 102 may operate a mobile device (such as a smart phone, tablet, or other mobile device that permits to perform, the subject method, e.g. an Apple iPhone, a BlackBerry, a Google Android driven phone or tablet, a Windows Phone, an iPad, or similar devices) and instantiate a ROP client mobile component to conduct sales analysis. In one implementation, the user may enter a plurality of sales parameters via a user interface, such as the product code 108a, product quantity 108b, projected price 108c, date of the sales event 108d, and/or the like. In one implementation, the user may vary the set price, e.g., by sliding a price range button 108c, to configure different product prices. Additional related parameters may include geo-location information of the user (e.g., GPS information, IP address, etc.), consumer purchasing history, and/or the like.

In one implementation, the ROP mobile component may provide sales analysis results via a user interface, which may comprise figures such as, but not limited to a sales price 109a, probability that a customer buys the product at the given sales price 109b, product code 109c, product quantity 109d, surplus revenue 109e (e.g., an amount of extra revenue that can be gained if the product is sold at the given sales price), a suggested optimal price 109f maximizes the expected revenue surplus, and/or the like. The sales person will be empowered to take an informed and quick decision about what price to quote to his prospective customer, with the help of the revenue maximization analysis on the basis of the processed past sales data.

FIGS. 1B-1C provide an exemplary block diagram illustrating aspects of price-oriented consumer clustering within alternative embodiments of the ROP. In one implementation, the sales event analysis and price optimization may be conducted based on a consumer clustering basis. For example, the ROP may apply behavioral clustering by analyzing the buying behavior of consumers to form “buying” clusters. In one implementation, the ROP server 120 may obtain purchasing history information 116a-c from a plurality of consumers, and group the consumers into clusters 115a-c based on their purchasing habits and pattern. For example, in one implementation, consumers may be clustered based on their purchasing product categories, e.g., electronics, beauty, grocery, etc. In another example, consumers may be clustered based on their spending amounts, e.g., average spending amount per month, etc. In one implementation, the ROP may segment sales data for each consumer cluster, and calculate an optimal price 118a-c per cluster. In alternative implementations, the consumer clustering segments may be established from customer relationship management data to calculate optimal prices per segment.

With reference to FIG. 1C, in one implementation, the consumer clustering may be based on the previous purchase data with regard to a product, e.g., “ABC insurance program.” In this example, target consumers of ABC insurance program are grouped based on their annual expenses 122a-c on ABC insurance programs.

FIG. 2 provides a data flow diagram illustrating exemplary data flows between the ROP and its affiliated entities within embodiments of the ROP. In FIG. 2, a user (or users) 202, merchant(s) 230, a ROP server 220, a ROP database 219, and/or the like are shown to interact via a communication network 213. The user 202, who may be a sales representative of the merchant 230, may operate a wide variety of different user devices, including communications devices and technologies within embodiments of ROP operation. For example, in one embodiment, the user devices may include, but are not limited to, computer terminals, workstations, cellular telephony handsets, smart phones, PDAs, and/or the like. In one embodiment, the ROP server 220 may be equipped at a terminal computer of the user 202. For example, the ROP component may be instantiated on a user device to conduct ROP analysis. In another embodiment, the ROP server 220 may be a remote server which is accessed by the user 202 via a communication network 213, such as, but not limited to local area network (LAN), in-house intranet, the Internet, and/or the like.

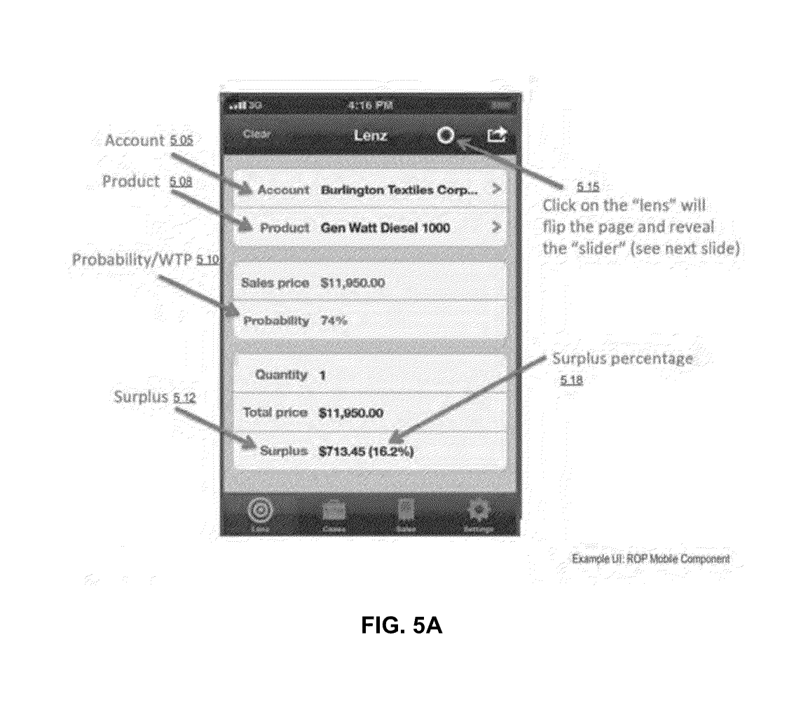

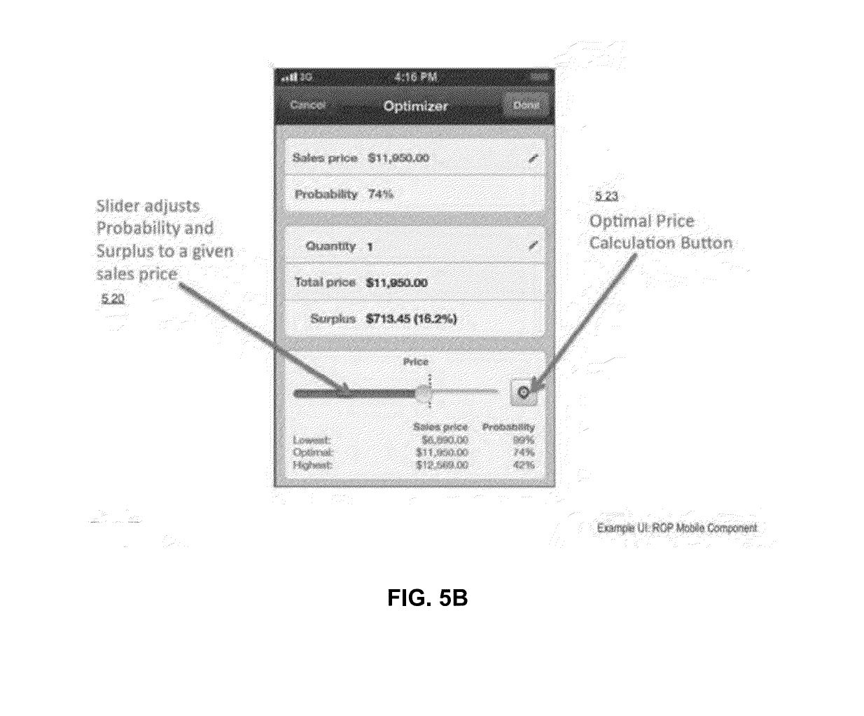

In one embodiment, the user 202 may obtain product information 205a from the merchant, such as but not limited to product code, product quantity, total price, date, and/or the like. In one implementation, the user 202 may send the obtained consumer data, seller data, product data, market data 205c, and user configured parameters (e.g., product price, quantity, etc.) 205b to the ROP server 220. In further implementations, the user 202 may provide geo-location information 205d, e.g., the GPS information, zip code, etc. to the ROP server 220. For example, in one implementation, the user 202 may set a price at his mobile device at a ROP mobile component user interface (e.g., see FIG. 5A). In another implementation, the user may upload a data file in the format of an excel spreadsheet, csv file, and/or the like to a ROP server 220.

For example, in one implementation, the user device 202 may provide a minimal input data set for the ROP server 220, including product code, quantity, a total price and date. The user device 202 may generate a minimal data input message to the ROP server as a HTTP(S) POST message including XML-formatted data. An example listing of a minimal data input message including user configured parameters 205b, substantially in the form of a HTTP(S) POST message including XML-formatted data, is provided below:

POST /min_input.php HTTP/1.1
Host: www.ROP.com
Content-Type: Application/XML
Content-Length: 667
<?XML version = “1.0” encoding = “UTF-8”?>
<min_input>

<input_ID> DSA_001 </input_ID>
<timestamp> 2013-09-09 12:23:23</timestamp>
<client>

<client_id> abc_001 </client_id>
<client_name> ABC insurance </client_name>
...

</client>
<minimal_dataset>

<product_id> GC1060 </product_id>
<quantity>10</quantity>
<total_price>680,000.00</total_price>
<date> 11/18/2014 </date>

</minimal_dataset>

...
</min_input>

In alternative implementations, the ROP server 220 may obtain an input dataset including past sales data 205a-d directly from a merchant 230, and/or from a relational database. For example, an exemplary relational database management system (RDBMS) schema of the minimal input dataset for ROP analysis may take a form similar to the following:

TABLE 1
Minimal Input Data Schema View

| Name | Data type | Nullable |
|---|---|---|
| Product_id | VARCHAR(30) | No |
| Quantity | SMALLINT | No |
| Revenue | DECIMAL(11, 2) | No |
| Sales_date | DATE | No |

In another example, an exemplary spreadsheet of minimal data set input may take a form similar to the following:

TABLE 2
Minimal Input Data Table Example

| Product Code | Quantity | Total Price (k) | Date |
|---|---|---|---|
| GC1060 | 10 | 680 | 11/18/2014 |
| GC5060 | 10 | 1350 | 11/18/2014 |
| GC3060 | 2 | 240 | 11/18/2014 |
| SL9060 | 3 | 79 | 10/25/2014 |
| GC1060 | 4 | 288 | 10/25/2014 |
| GC3060 | 2 | 200 | 10/25/2014 |
| SL9040 | 2 | 35 | 10/25/2014 |
| GC3040 | 15 | 577 | 9/24/2014 |
| GC5040 | 12 | 738 | 9/24/2014 |
| SL9020 | 12 | 108 | 9/24/2014 |
| SL9040 | 3 | 57 | 9/24/2014 |

In further implementations, the ROP server 220 may leverage additional input data for ROP analysis, to analyze relationships found between sales data, and optionally additional metrics associated with past transactions; and/or customer data, such as, customer demographics, customer financials, additional customer relationship management information, and the like; and segments; seller data, such as seller demographics, seller organization/division information, sales performance information, and the like, product data such as production/cost structure and data, and the like, market data such as competition prices, quantifiable market trend data, and the like, 205c, geo-location data 205d, and/or events for executing optimization of the sales price, sales revenue and/or success rate of sales transaction, and/or the like.

For example, an exemplary RDBMS schema of a richer input dataset for ROP analysis may take a form similar to the following:

TABLE 3
Richer Input Data Schema View

| NAME | DATA TYPE | NULLABLE |
|---|---|---|
| PRODUCT_ID | VARCHAR(30) | NO |
| QUANTITY | SMALLINT | NO |
| REVENUE | DECIMAL(11, 2) | NO |
| SALES_DATE | DATE | NO |
| CUSTOMER_ID | VARCHAR(30) | YES |
| CUSTOMER_SEGMENT_ID | VARCHAR(30) | YES |
| SALES_PERSON_ID | VARCHAR(30) | YES |
| SALES_PERSON_NAME | VARCHAR(150) | YES |
| SALES_AREA_NAME | VARCHAR(50) | YES |
| UNIT_LIST_PRICE | DECIMAL(11, 2) | YES |
| UNIT_SALE_PRICE | DECIMAL(11, 2) | YES |
| UNIT_COST | DECIMAL(11, 2) | YES |
| MAIN_COMPET- | DECIMAL(11, 2) | YES |
| ITOR_UNIT_LIST_PRICE | | |

As shown above, the richer data set may comprise product code, quantity, total prices, date, customer code, which may be obtained from an enterprise resource planning (ERP) or CRM data repository of the merchant 220. The richer data set may further comprise a customer segment code indicating segment computed for consumer clustering using CRM data. In further implementations, the richer data set may comprise information on the sales person who performed the sales, e.g., sales person code, and/or additional sales person performance data. The richer data set may further comprise data maintained in an ERP/CRM data repository from the merchant including base price and discount, etc.

For example, an exemplary spreadsheet of richer data set input may take a form similar to the following:

TABLE 4
Richer Input Data Set Table Example

| | | Total | | | Customer | Sales | | |
|---|---|---|---|---|---|---|---|---|
| Product | | Price | | Customer | Segment | Person | Base | |
| Code | Quantity | (k) | Date | code | Code | Code | Price | Discount |
| GC3040 | 15 | 577 | 9/24/2014 | CC634267 | 2 | SP001 | 50 | 23% |
| GC5040 | 12 | 738 | 9/24/2014 | CC634267 | 2 | SP001 | 75 | 18% |
| SL9020 | 12 | 108 | 9/24/2014 | CC634267 | 2 | SP001 | 10 | 10% |

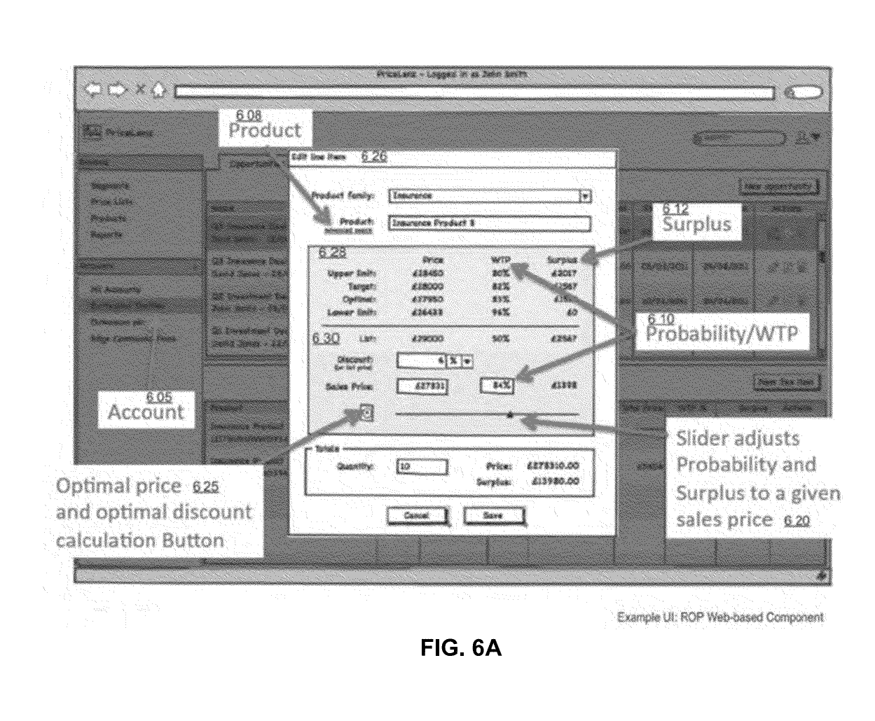

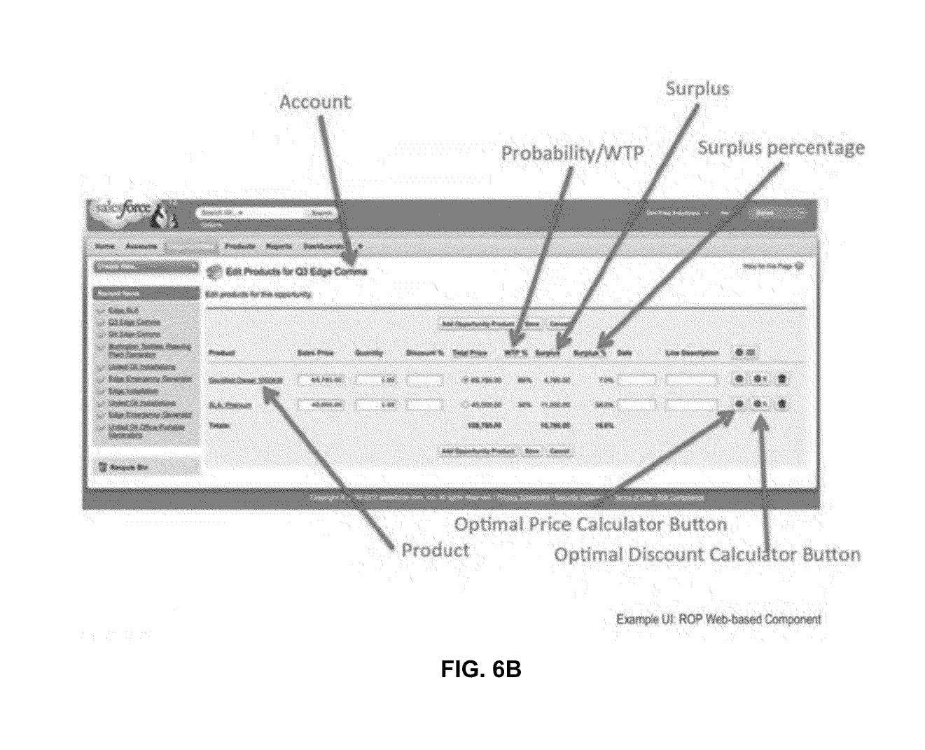

In one implementation, upon receiving user provided data 205a-d, the ROP server 220 may perform predictive analysis (e.g., sales forecasting, price optimization, etc.) 223 to generate sales forecasting results. In one implementation, the ROP server may generate an output screen of purchasing prediction results, optimized price, and/or the like 211 to the user 202 via a user interface. For example, in one implementation, a screen of prediction results may take a form similar to that shown in FIGS. 5A-6B.

In some embodiments, the ROP server 220 may generate a project record 225 including the input data set, and the generated prediction results. For example, the ROP server may store the user record data including the data input and the generated prediction results 211 in a ROP data server 219. For example, the ROP server may issue PHP/SQL commands to store the data to a database table. An example purchasing prediction results store command, substantially in the form of PHP/SQL commands, is provided below:

<?PHP
header(′Content-Type: text/plain′);
mysql_connect(″121.122.123.124”,$DBserver,$password); // access
database server
mysql_select(″ROP_DB.SQL″); // select database to append
mysql_query(“INSERT INTO PredictionTable (product_id, quantity,

sales_price , probability, surplus)

VALUES (GC3040, 15, 0.74, 713.5)”); // add data to table in database
mysql_close(″ROP_DB.SQL″); // close connection to database
?>

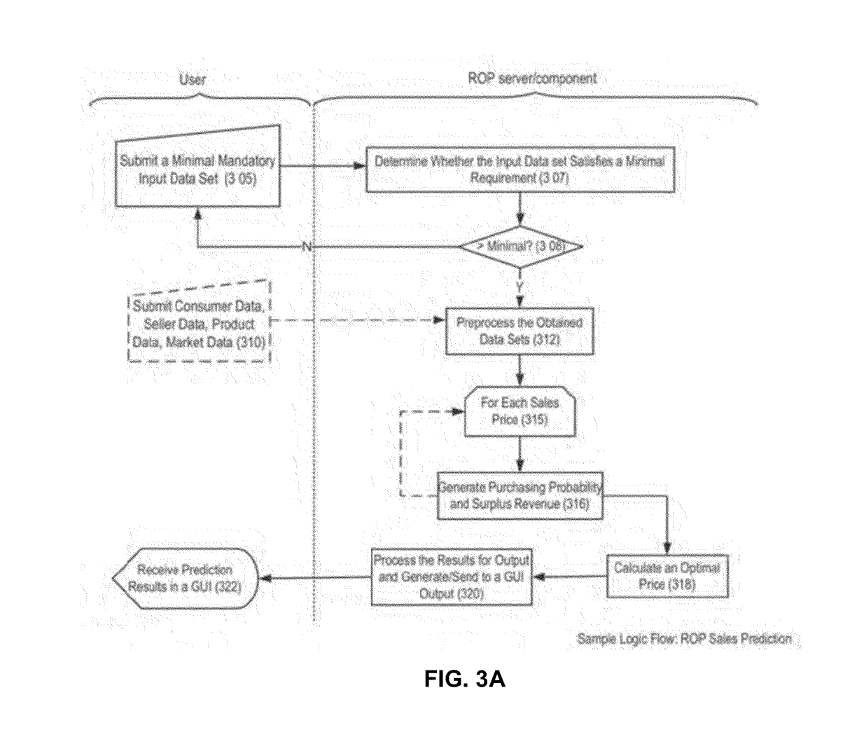

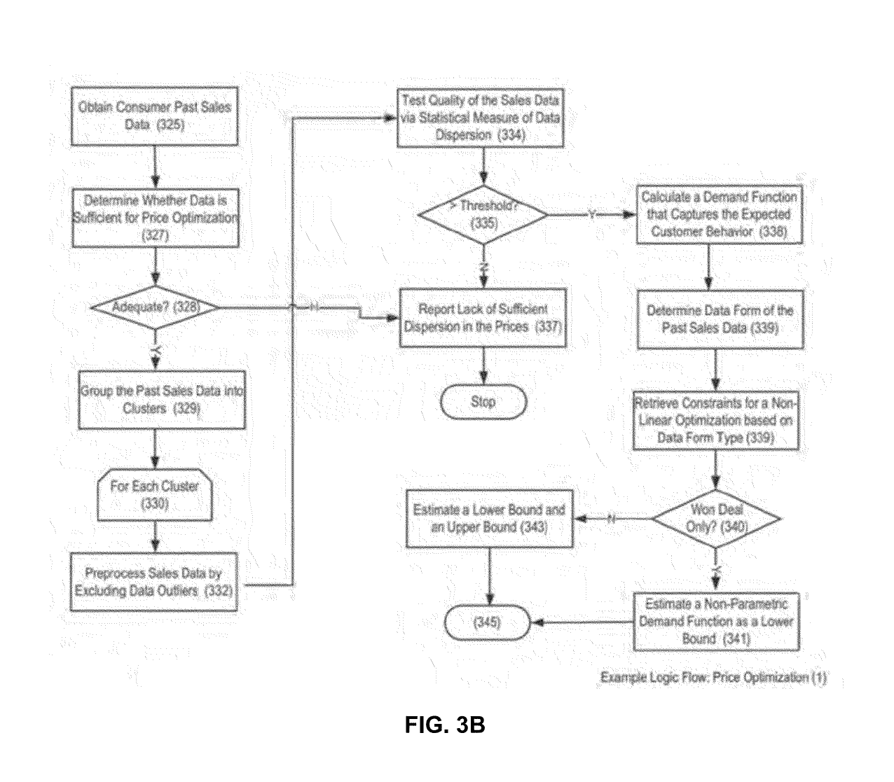

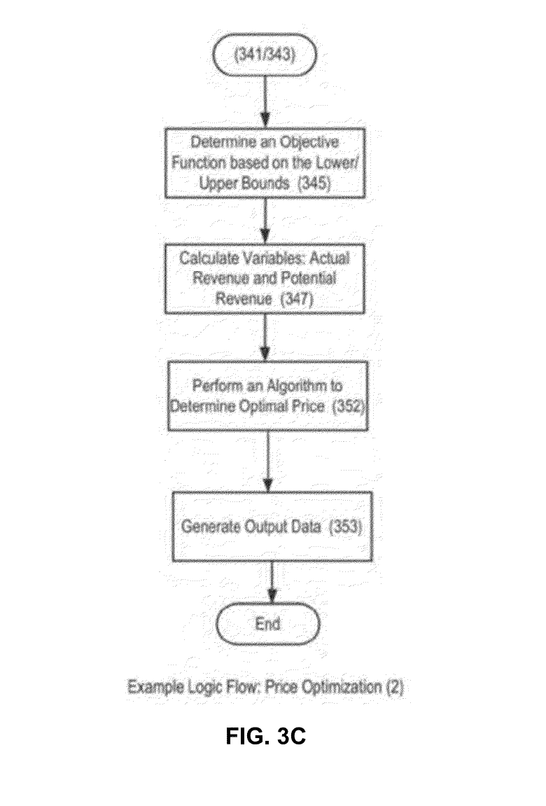

FIGS. 3A-3C provide exemplary logic flow diagrams illustrating ROP sales prediction analysis within embodiments of the ROP. With reference to FIG. 3A, the ROP sales prediction may start with a user submitting a minimal mandatory input dataset 305 to the ROP server/client component. In one implementation, the ROP may determine whether the received input dataset satisfies a minimal requirement 307, e.g., the input dataset should comprise at least the product code, quantity, sales price and a project date. If the dataset satisfies the minimal requirement 308, the ROP may preprocess the obtained datasets 312. Otherwise, the user may be directed to re-enter the input data at 305. In other implementations, the user may submit additional data such as consumer data, seller data, product data, market data 310, and/or the like, e.g., see 205c in FIG. 2.

In one implementation, for each sales price 315, the ROP may generate a purchasing probability and a surplus revenue 316. The ROP may further calculate the optimal price 318, and process the results for the output and send them over to the web page or any other GUI 320. The user may then receive prediction results in a graphic user interface 322, e.g., see FIGS. 5A-6B.

FIG. 3B-3C provide logic flow diagrams illustrating aspects of optimal price calculation 318 within embodiments of the ROP. Within implementations, the ROP may obtain consumer past sales data 325. For example, the ROP may obtain such data from a consumer past sales data database. In one implementation, the ROP may apply criteria used in order to choose data from the database, and check the data quality and preprocess in order to provide it to the main part of an optimization procedure which generates the optimal price calculation.

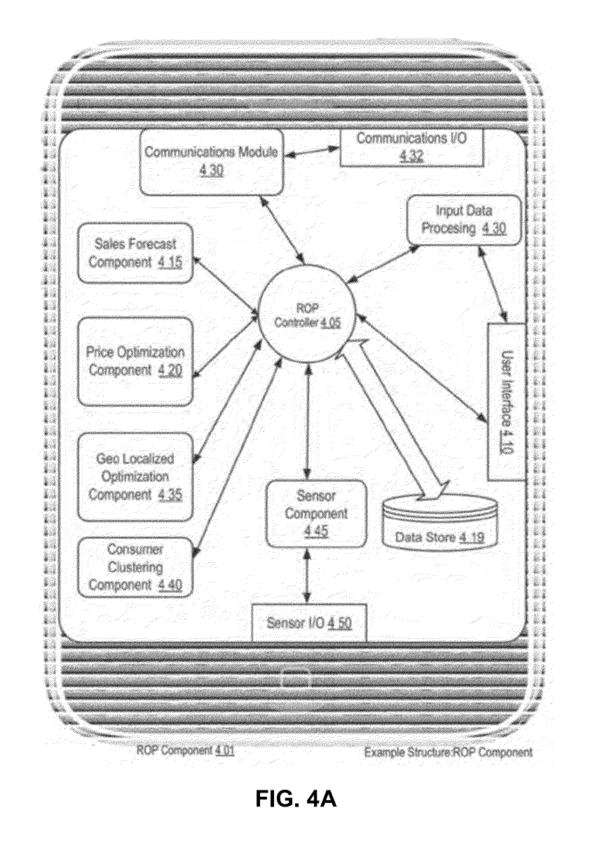

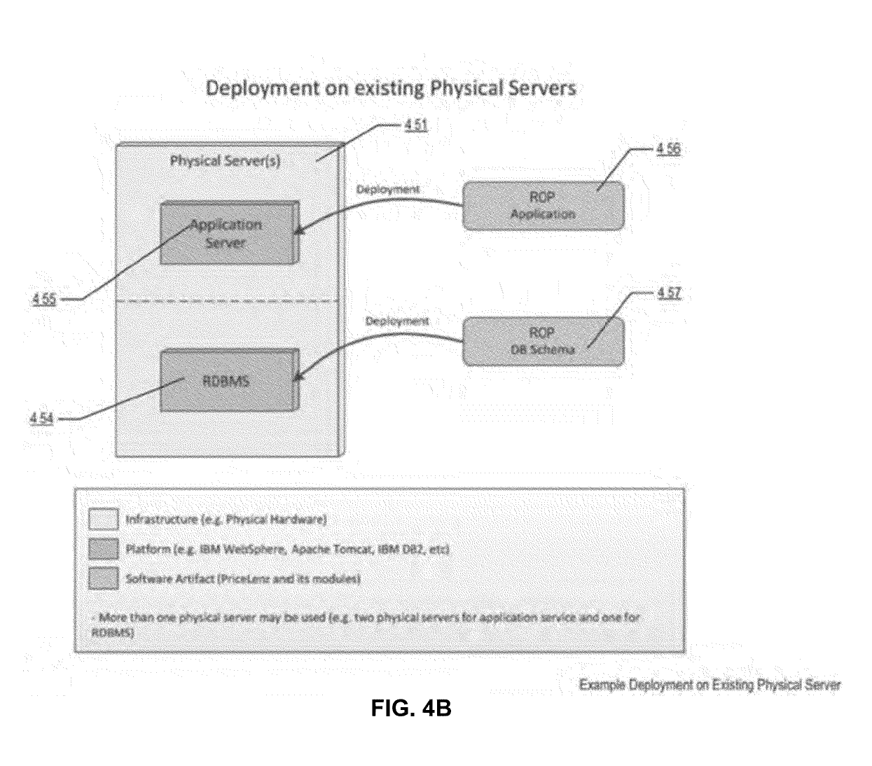

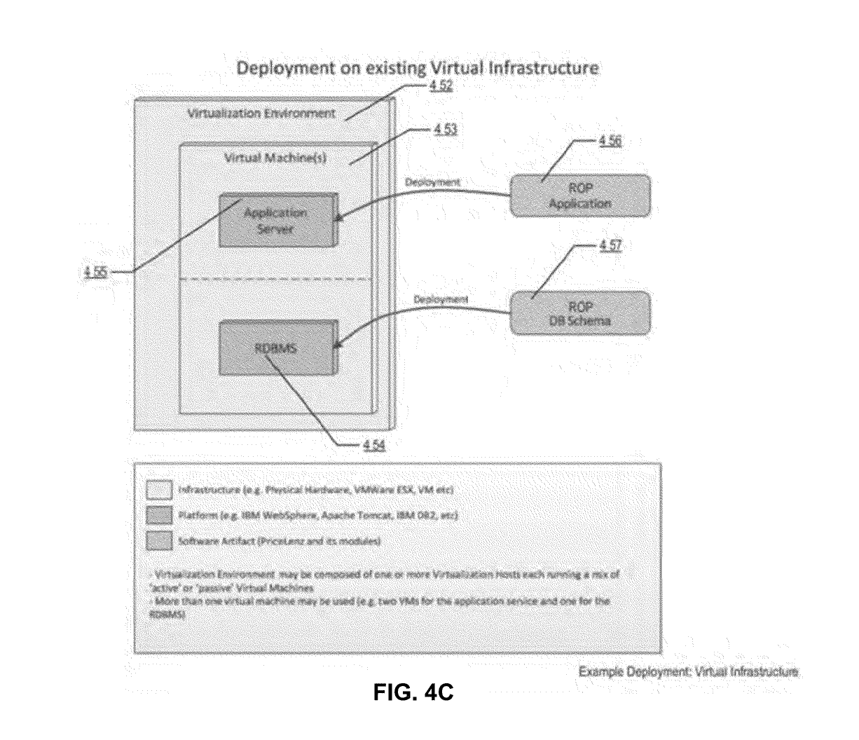

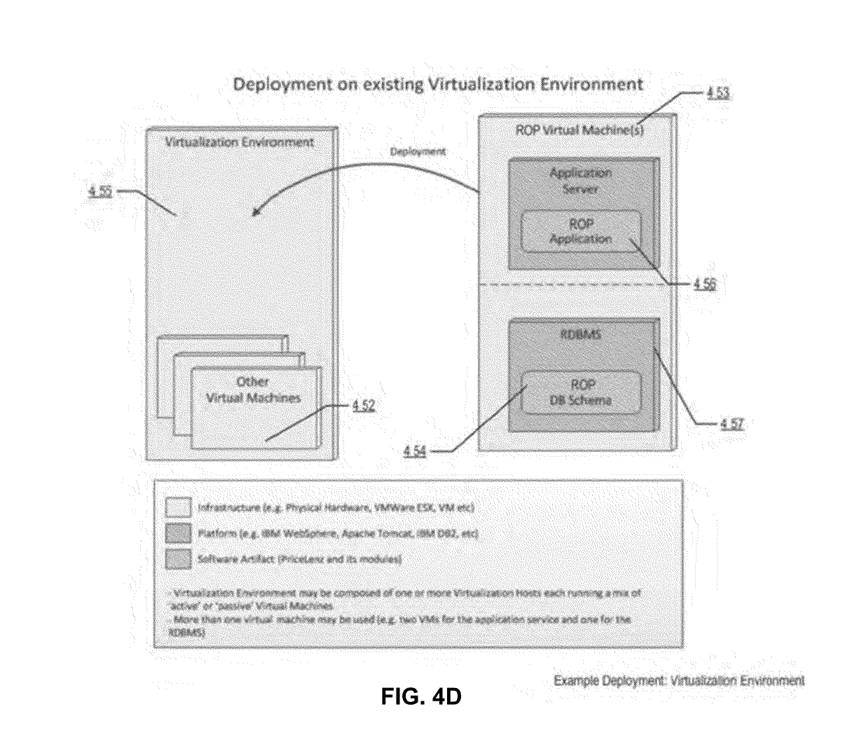

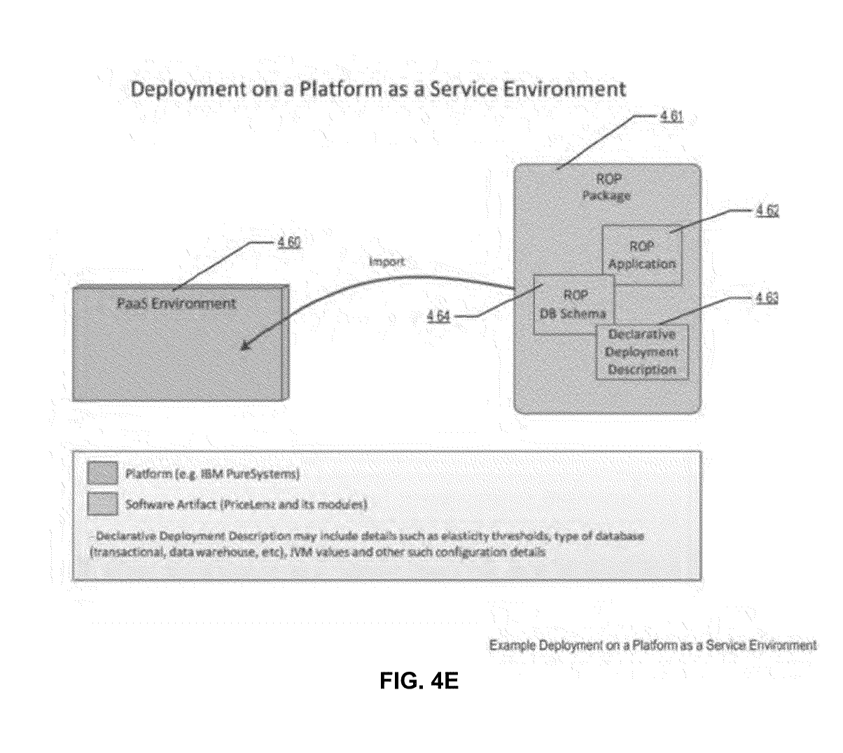

In one implementation, the ROP may determine whether the obtained sales data is adequate and suitable for optimal price calculation 327. If the obtained data is not adequate 328, the ROP may report lack of sufficient data 337. If the obtained data is adequate 328, the ROP may group the past sales data into clusters 329. For example, a module for data segmentation (e.g., 440 in FIG. 4A) may group the past sales data into clusters, where each cluster corresponds to a combination of a particular product and a specific market segment, such a combination henceforth simply referred to as “segment”. The process of data segmentation may include data mining procedures whereby data segmentation is described as a mathematical optimization problem and an objective function is optimized. The data segmentation may be based on a specific product id, currency and/or the current customer segment.

In one implementation, for each cluster/segment 330, the ROP may preprocess sales data and test the data quality 332. For example, for the sales data in the form of won deals only, or in the form of both won and lost deals, the ROP may estimate a demand function and perform optimization procedures under different constraints.

In one implementation, the ROP may clean the sales data by excluding data outliers (very high or low sales prices) 332, as it is assumed that these sales may exist either due to some kind of product promotion (for example free products acquisition to persuade the customers buy in the future) or because of a typo or other kind of mistake when inserting the data into the database and such “outliers” shall be excluded from further analysis.

The ROP may then test quality of the sales data through statistical measures of data dispersion 334, e.g., the Gini index. For example, given a set of prices p1, . . . , pn, the dispersion measure calculates the Gini coefficient G:

$$G = 1 - \frac{{\sum }_{i = 1}^{n} f ( {p}_{i} ) ( {S}_{i - 1} + {S}_{i} )}{{S}_{n}}$$

$$where$$

$${S}_{i} = {\sum }_{j = 1}^{i} f ( {p}_{j} ) {p}_{j} and {S}_{0} = 0$$

If the dispersion measure G is above a certain threshold 335 (e.g., 0.4, etc.), the ROP may proceed with data processing, otherwise the algorithm terminates and reports lack of sufficient dispersion in the prices 337. If the dispersion test succeeds 335, the ROP may proceed with the calculation of a demand function that captures the expected behavior of a customer from the particular segment 338.

In one implementation, the ROP may proceed to the actual calculation of the optimal price for a specific product. The ROP may determine a data from of the past sales data 339. For example, depending on whether past data in this segment appear in the form of won deals only or in the form of both won and lost deals in one embodiment 340, the ROP may perform demand function estimation with a mathematical optimization under different constraints 339. If only won deals are available 340, the ROP may estimate a non-parametric demand function as a lower bound of the true demand function 341.

For example, in one implementation, given a set of prices pw1, . . . , pwₙ of past won sales, the empirical (cdf) cumulative density function may be generated, based on which a non-parametric demand function as 1-cdf. This function is a lower bound to the true demand function because the true reservation prices of the customers who bought at prices pw1, . . . , pwₙ must necessarily be above pw1, . . . , pwₙ, respectively.

In an alternative implementation, if lost deals are additionally available in the particular embodiment 340, a lower as well as an upper bound to the true demand function may be estimated by a similar procedure 343. For example, given a set of prices pl1, . . . , plₘ of past lost sales, an empirical (cdf) cumulative density function may be generated, based on which a non-parametric demand function is obtained as 1-cdf. This function may set an upper bound to the true demand function because the true reservation prices of the customers who did not buy at prices pl1, . . . , plₘ must necessarily be below pl1, . . . , plₘ, respectively. Within implementations, these bounds may act as constraints in a mathematical nonlinear optimization procedure that fits a given parametric form of a demand function so that it respects the said bounds.

Continuing on with FIG. 3C, the ROP may determine an objective function for a given parametric demand function 345, e.g., a sigmoid function, which measures the degree of fit of the parametric demand function within the said lower and upper bounds. The ROP may then calculate a plurality of variables including actual revenue, potential revenue 347, and/or the like.

For example, in one implementation, in a non-activated version of the ROP, the following variables may be calculated:

$$Actual Revenue = {\sum }_{all sold products i} {quantity}_{i} {price}_{i}$$

$$Potential Revenue = {\sum }_{all sold product i} {quantity}_{i} optimal {Price}_{i} ( \frac{{WTP}_{{optimal}_{i}}}{{WTP}_{i}} )$$

$$Increase Potential = Potential Revenue - Actual Revenue$$

$$Increase Potential Percent = Increase Potential \times 100 \%$$

For an activated version of the ROP, the optimal price and the willingness to pay may be generated via a procedure 352, and also the following variables may be generated:

$$Base {Price}_{i} = {min}_{all j prices of product i} {price}_{i , j}$$

$$Actual Unit {Price}_{i} = Unit {Price}_{i} \times ( 1 - {Discount}_{i} )$$

$${Surplus}_{i , j} = {Price}_{i} i , j - Base {Price}_{i}$$

$$Surplus {Percent}_{i , j} = {Surplus}_{i , j} \times 100 \%$$

where i refers to one specific product and j refers to one specific price of item i.

In another implementation, having an estimation of the demand function, the ROP may calculate the surplus function as below:

Surplus_{i,j}=Demand Function Probability_{i,j}×(Price_{i,j}−BasePriceᵢ)

Within implementations, the ROP may perform an optimization procedure to calculate an optimal price. For example, the demand function may be obtained based on the past won quotes made on a specific product, in a specific currency using a single customer segment. For example, the ROP may determine an optimal price and the willingness to pay (WTP) that corresponds to that price. In order to take the WTP for any other price, a distance matrix defined in the procedure and the given price may be applied.

Within implementations, the ROP may generate output data 353, and transmit the output data to the end user. In one embodiment, the demand function may be interpolated and sampled at regular Intervals. For example, the ROP may adopt monotone cubic interpolation to obtain a compact data structure that form a smooth line describing the demand function and that can be sampled and transferred to the portable computing device. In further implementations, the ROP may apply the interpolation algorithm to reproduce the data on a user mobile device. Further implementations of the optimal price calculation procedure and the monotone cubic interpolation are discussed in F. Fritsch and R. Carlson, “Monotone Piecewise Cubic Interpolation,” SAIM Journal on Numerical Analysis, 17 (2):238-246, 1980; C. Gini, “On the Measure of Concentration with Special Reference to Income and Statistics,” (208):73-79; and M. Z. Hussain and M. Sarfraz, “Monotone Piecewise Rational Cubic Interpolation,” Int. J. Comput. Math., 86 (3):423-430, March 2009. All of the aforementioned publications are herein expressly incorporated by reference.

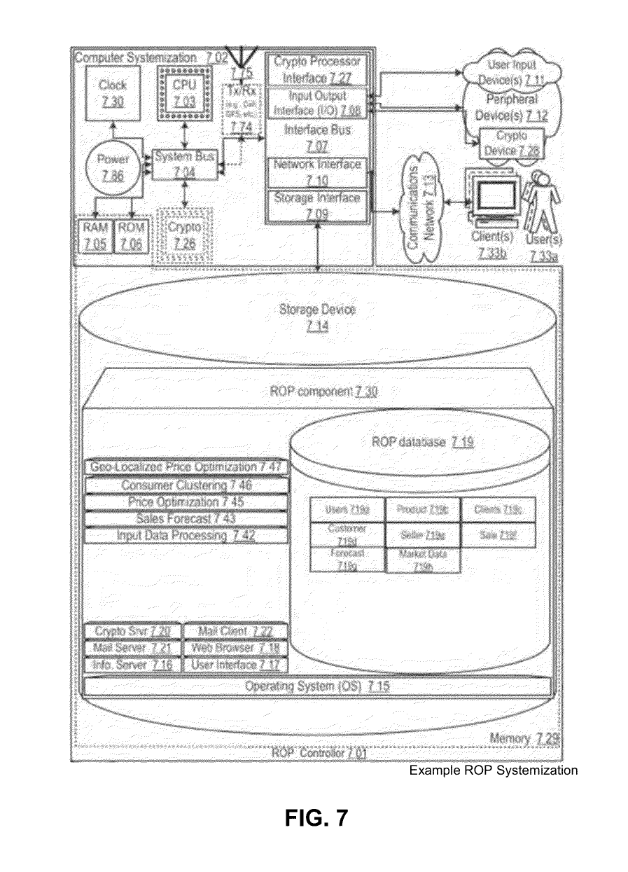

FIG. 4A provides a block diagram illustrating a ROP client component within embodiments of the ROP. Within embodiments, a ROP component 401 may contain a number of sub-components and/or data stores. A ROP client controller 405 may serve a central role in some embodiments of ROP operation, serving to orchestrate the reception, generation, and distribution of data and/or instructions to, from and between client mobile device(s) and/or the server via ROP components and in some instances mediating communications with external entities and systems. Further discussion of the ROP controller 405 is provided in FIG. 7.

In one embodiment, the ROP controller 405 and/or the different components may be instantiated on a user mobile device, e.g., an Apple iPhone, a BlackBerry, a Google Android, etc. In an alternative embodiment, the controller may be housed separately from other components and/or databases within the ROP system, while in another embodiment, some or all of the other modules and/or databases may be housed within and/or configured as part of the ROP controller. Further detail regarding implementations of ROP controller operations, modules, and databases is provided below.

In one embodiment, the ROP controller 405 may be coupled to one or more interface components and/or modules. In one embodiment, the ROP Controller may be coupled to a user interface (UI) 410. The user interface 410 may be configured to receive user inputs and display application states and/or other outputs. The UI may, for example, allow a user to enter sales price parameters, adjust ROP system settings, select communication methods and/or protocols, manually enter texts, engage mobile device application features, and/or the like. In one implementation, the user interface 410 may include, but not limited to devices such as, keyboard(s), mouse, stylus(es), touch screen(s), digital display(s), and/or the like. For example, the user interfaces 410 may comprise a touch mobile screen providing displaying prediction results to the user, e.g., see 510/512 FIG. 5A

In one implementation, the ROP Controller 405 may further be coupled to a sensor module 445, configured to interface with and/or process signals from sensor input/output (I/O) components 450. The sensor I/O components 450 may be configured to obtain information of user geo-locations, and/or the like to generate user geographic information for consumer segment/clustering. A wide variety of different sensors may be compatible with ROP operation and may be integrated with sensor I/O components 445, such as but not limited to a GPS component, and/or the like.

In one implementation, the consumer clustering component 440 may obtain behavioral information of consumers and determine “buying” customer clusters based on their buying behaviors, e.g., see FIG. 1B. A sales forecast component 415 may generate customer purchasing probability and revenue prediction based on obtained input data set, and the price optimization component 420 may provide a suggested optimal price based on the sales forecast results. In further implementations, the geo-localized optimization component 435 may facilitate a user to turn on the localization feature of the device (e.g., a GPS sensor, etc.) and select tat that are relevant for the pricing optimization which include his current location, e.g., a constrained dataset based on geographic information of the customer, sales position or any combination of geo-localized sales data information. The geo-localized optimization component may retrieve the geo-localized optimal price, probability and surplus revenue for the product.

In one embodiment, the ROP Controller 405 may further be coupled to a communications module 430, configured to interface with and/or process data transmission from communications I/O components 432. The communications I/O components 432 may comprise components facilitating transmission of electronic communications via a variety of different communication protocols and/or formats as coordinated with and/or by the communications module 430. Communication I/O components 440 may, for example, contain ports, slots, antennas, amplifiers, and/or the like to facilitate transmission of TV program listing information, user submission of channel selection, user responses to survey questions, and/or the like, via any of the aforementioned methods. Communication protocols and/or formats for which the communications module 430 and/or communications 10 components 432 may be compatible may include, but are not limited to, GSM, GPRS, W-CDMA, CDMA, CDMA2000, HSDPA, Ethernet, WiFi, Bluetooth, USB, and/or the like. In various implementations, the communication I/O 432 may, for example, serve to configure data into application, transport, network, media access control, and/or physical layer formats in accordance with a network transmission protocol, such as, but not limited to FTP, TCP/IP, SMTP, Short Message Peer-to-Peer (SMPP) and/or the like. The communications module 430 and communications I/O 432 may further be configurable to implement and/or translate Wireless Application Protocol (WAP), VoIP and/or the like data formats and/or protocols. The communications I/O 432 may further house one or more ports, jacks, antennas, and/or the like to facilitate wired and/or wireless communications with and/or within the ROP system. For example, the communication I/O 432 and communication module 430 may be configured to access one or more online data store (e.g., a merchant repository, etc.) to load datasets from a repository (e.g., see 205c in FIG. 2).

Numerous data transfer protocols may also be employed as ROP connections, for example, TCP/IP and/or higher protocols such as HTTP post, FTP put commands, and/or the like. In one implementation, the communications module 430 may comprise web server software equipped to configure application state data for publication on the World Wide Web. Published application state data may, in one implementation, be represented as an integrated video, animation, rich internet application, and/or the like configured in accordance with a multimedia plug-in such as Adobe Flash. In another implementation, the communications module 430 may comprise remote access software, such as Citrix, Virtual Network Computing (VNC), and/or the like equipped to configure user application (e.g., a user mobile device).

Within alternative embodiments, the ROP may comprise a database 419 of past sales data, a module for data segmentation/clustering 440, a module for demand function estimation, a module for transferring data to portable computing devices, a portable price optimizer, and a graphical user interface on the portable device. The said database comprises past sales data. In different embodiments, the sales data may appear in the form of won deals only, or in the form of both won and lost deals. Depending on which of the two forms applies in the particular embodiment, the module for demand function estimation performs optimization functions under different constraints, as described in FIGS. 3B-3C.

The portable price optimizer may comprise a system and a collection of methods that run on a portable computing device such as mobile phone or tablet personal computer. The system implements a collection of methods that perform price optimization and management. The main method takes as input a compact description of the demand function from the said module for data transfer, estimates an expected utility function (revenue or profit function depending on the preferred embodiment), and subsequently computes the optimal price for the given segment which is the price that maximizes a selected objective function (e.g., utility), e.g., see 345 in FIG. 3C.

FIGS. 4B-4E provide block diagrams illustrating various ROP deployment options within embodiments of the ROP. Within implementations, a ROP component may have various deployment options. For example, with reference to FIG. 4B, the ROP component may be directly deployed (non-virtualized) on an existing physical server, e.g., the application server 455 and database 454 installed on a physical server 451. In this way the software artifacts, e.g., the ROP application 456 may be deployed on the application server 455, and ROP database schema 457 may be deployed on the RDBMS 454. In one implementation, the application server 455 and RDBMS 454 may include platforms such as but not limited to IBM WebSphere, Apache Tomcat, IBM DB2, and/or the like.

In alternative implementations, the ROP may establish virtualized images (e.g., virtual appliance) for deployment, e.g., the ROP may be deployed as one or more virtual machines (e.g. VMware images). For example, with reference to FIG. 4C, a virtualization environment 452 may host an application server 455 and a RDBMS 454 on a virtual machine 453. In this way, virtualization environment may be composed of one or more virtualization hosts each running a mix of “active” or “passive” virtual machines. In further implementations, more than one virtual machine may be used (e.g., two virtual machines for the application service and one for the RDBMS). In one implementation, the ROP application 456 may be deployed on an application server 455, and the ROP database schema 457 is stored in a RDBMS within the virtual machine.

In an alternative implementation, with reference to FIG. 4D, the ROP may deploy the whole virtual machine 253 including the application server 255 running the ROP application 456 and the RDBMS 454 storing ROP schema 457 in a virtualization environment 452.

In an alternative implementation, with reference to FIG. 4E, the ROP may be deployed as a “pattern” containing the code package 461, which in turn comprises the ROP application 462, ROP data schema 464, and a declarative description 463 of application server and database middleware deployment configuration. In one implementation, the declarative deployment description may include details such as elasticity thresholds, type of database (e.g., transactional, data warehouse, etc.), JVM values, and other configuration details. The ROP package 461 may be imported to a PaaS environment 460 for deployment. For example, the ROP may be deployed on IBM PureSystems (e.g. a private and/or public cloud), or IBM SmartCloud Enterprise (e.g. public cloud), and/or the like.

FIG. 5A-5B provide exemplary mobile component user interfaces illustrating ROP mobile component data output within embodiments of the ROP. With reference to FIG. 5A, a mobile screen may be provided to a user comprising a plurality of data elements. For example, the data element “account” 505 may provide information of the customer or a prospective customer who is the target of the sale, e.g., “Burlington Textile Corporations,” etc. The data element “product” 508 may indicate a uniquely identified good or service that is proposed to the “account” customer, e.g., “Gen Watt Diesel 1000.” The data element “Sales Price” may provide the unit price for the proposed sale. The data element “Probability/WTP” 510 may provide a probability that a customer buys the “Product” at the given “Sales Price,” e.g., 74%. The data element “Surplus” 512 may indicate the amount of extra revenue that may be gained if this “Product” is sold at the given “Sales Price,” additional to the revenue at the 100% probability (e.g., the lowest known price to date or lowest limit price). The surplus may also be presented as a surplus percentage 518, which shows an increase over the price associated to the 100% probability.

In one implementation, the ROP mobile component may comprise a “lens” button 515, wherein a user may click on the button to flip the page to see the price “sliding” option and optimal price calculation that provides an optimal price that maximizes the expected revenue surplus.

Continuing on with FIG. 5B, if a user has clicked on the “lens” button 515 in FIG. 5A, the mobile component may provide a screen comprising a slider 520. A user may slide the sliding button to vary the sales price, and the ROP may calculate the probability and surplus revenue, which correspond to the changed sales price.

In a further implementation, the ROP mobile component may provide an optimal price calculation button 523, which may trigger the optimal calculation and return a suggested optimal price (e.g., as discussed in FIGS. 3B-3C).

FIGS. 6A-6B provide exemplary web-based user interfaces illustrating data input and output within alternative embodiments of the ROP. With reference to FIG. 6A, a web-based ROP page may provide data fields such as account 605, product 608, surplus 612, probability/WTP 610, an optimal price button 625, price slider 620, and/or the like. In one implementation, the ROP may provide a floating window 626 for a user to enter information. For example, the floating window may provide a data section 628 providing upper/lower price limits, target price and optimal price. In one implementation, the user may enter a discount rate, e.g., 4%. The user may obtain an optimal discount that corresponds to the optimal price over the list price.

In further implementations, the sales probability calculation may be performed in two directions. In one implementation, the user may enter a sales price and obtain from the ROP a calculated purchasing probability and surplus revenue. In another implementation, the user may enter a desired purchasing probability and/or surplus revenue and obtain from the ROP a suggested price that corresponds to the purchasing probability.

FIG. 6B provide a web-based ROP user interface in an alternative format, including similar data fields as shown in FIG. 6A.

### ROP Controller

FIGURE shows a block diagram illustrating example aspects of a ROP controller 01. In this embodiment, the ROP controller 01 may serve to aggregate, process, store, search, serve, identify, instruct, generate, match, and/or facilitate interactions with a computer through various technologies, and/or other related data.

Users, e.g., 33a, which may be people and/or other systems, may engage information technology systems (e.g., computers) to facilitate information processing. In turn, computers employ processors to process information; such processors 03 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 29 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ROP controller 01 may be connected to and/or communicate with entities such as, but not limited to: one or more users from user input devices 11; peripheral devices 12; an optional cryptographic processor device 28; and/or a communications network 13. For example, the ROP controller 01 may be connected to and/or communicate with users, e.g., 33a, operating client device(s), e.g., 33b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ROP controller 01 may be based on computer systems that may comprise, but are not limited to, components such as: a computer systemization 02 connected to 29.

### Computer Systemization

A computer systemization 02 may comprise a clock 30, central processing unit (“CPU(s)” and/or “processor(s)” (these terms are used interchangeably throughout the disclosure unless noted to the contrary)) 03, a memory 29 (e.g., a read only memory (ROM) 06, a random access memory (RAM) 05, etc.), and/or an interface bus 07, and most frequently, although not necessarily, are all interconnected and/or communicating through a system bus 04 on one or more (mother)board(s) 02 having conductive and/or otherwise transportive circuit pathways through which instructions (e.g., binary encoded signals) may travel to effectuate communications, operations, storage, etc. The computer systemization may be connected to a power source 86; e.g., optionally the power source may be internal. Optionally, a cryptographic processor 26 and/or transceivers (e.g., ICs) 74 may be connected to the system bus. In another embodiment, the cryptographic processor and/or transceivers may be connected as either internal and/or external peripheral devices 12 via the interface bus I/O. In turn, the transceivers may be connected to antenna(s) 75, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing ROP controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM4750IUB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 29 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the ROP controller and beyond through various interfaces. Should processing requirements dictate a greater amount speed and/or capacity, distributed processors (e.g., Distributed ROP), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the ROP may be achieved by implementing a microcontroller such as CAST's R8051XC2 microcontroller; Intel's MCS 51 (i.e., 8051 microcontroller); and/or the like. Also, to implement certain features of the ROP some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ROP component collection (distributed or otherwise) and/or features may be implemented via the microprocessor and/or via embedded components; e.g., via ASIC, coprocessor, DSP, FPGA, and/or the like. Alternately, some implementations of the ROP may be implemented with embedded components that are configured and used to achieve a variety of features or signal processing.

Depending on the particular implementation, the embedded components may include software solutions, hardware solutions, and/or some combination of both hardware/software solutions. For example, ROP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ROP features. A hierarchy of programmable interconnects allow logic blocks to be interconnected as needed by the ROP system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the ROP may be developed on regular FPGAs and then migrated into a fixed version that more resembles ASIC implementations. Alternate or coordinating implementations may migrate ROP controller features to a final ASIC instead of or in addition to FPGAs. Depending on the implementation all of the aforementioned embedded components and microprocessors may be considered the “CPU” and/or “processor” for the ROP.

### Power Source

The power source 86 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 86 is connected to at least one of the interconnected subsequent components of the ROP thereby providing an electric current to all the interconnected components. In one example, the power source 86 is connected to the system bus component 04. In an alternative embodiment, an outside power source 86 is provided through a connection across the I/O 08 interface. For example, a USB and/or IEEE 1394 connection carries both data and power across the connection and is therefore a suitable source of power.

### Interface Adapters

Interface bus(ses) 07 may accept, connect, and/or communicate to a number of interface adapters, frequently, although not necessarily in the form of adapter cards, such as but not limited to: input output interfaces (I/O) 08, storage interfaces 09, network interfaces 10, and/or the like. Optionally, cryptographic processor interfaces 27 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 09 may accept, communicate, and/or connect to a number of storage devices such as, but not limited to: storage devices 14, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 10 may accept, communicate, and/or connect to a communications network 13. Through a communications network 13, the ROP controller is accessible through remote clients 33b (e.g., computers with web browsers) by users 33a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed ROP), architectures may similarly be employed to pool, load balance, and/or otherwise increase the communicative bandwidth required by the ROP controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 10 may be used to engage with various communications network types 13. For example, multiple network interfaces may be employed to allow for the communication over broadcast, multicast, and/or unicast networks.

Input Output interfaces (I/O) 08 may accept, communicate, and/or connect to user input devices 11, peripheral devices 12, cryptographic processor devices 28, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 11 often are a type of peripheral device 12 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 12 may be connected and/or communicate to I/O and/or other facilities of the like such as network interfaces, storage interfaces, directly to the interface bus, system bus, the CPU, and/or the like. Peripheral devices may be external, internal and/or part of the ROP controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 28), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the ROP controller may be embodied as an embedded, dedicated, and/or monitor-less (i.e., headless) device, wherein access would be provided over a network interface connection.

Cryptographic units such as, but not limited to, microcontrollers, processors 26, interfaces 27, and/or devices 28 may be attached, and/or communicate with the ROP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 29. However, memory is a fungible technology and resource, thus, any number of memory embodiments may be employed in lieu of or in concert with one another. It is to be understood that the ROP controller and/or a computer systemization may employ various forms of memory 29. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 29 may include ROM 06, RAM 05, and a storage device 14. A storage device 14 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 29 may contain a collection of program and/or database components and/or data such as, but not limited to: operating system component(s) 15 (operating system); information server component(s) 16 (information server); user interface component(s) 17 (user interface); Web browser component(s) 18 (Web browser); database(s) 19; mail server component(s) 21; mail client component(s) 22; cryptographic server component(s) 20 (cryptographic server); the ROP component(s) 35; and/or the like (i.e., collectively a component collection). These components may be stored and accessed from the storage devices and/or from storage devices accessible through an interface bus. Although non-conventional program components such as those in the component collection may be stored in a local storage device 14, they may also be loaded and/or stored in memory such as: peripheral devices, RAM, remote storage facilities through a communications network, ROM, various forms of memory, and/or the like.

### Operating System

The operating system component 15 is an executable program component facilitating the operation of the ROP controller. The operating system may facilitate access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsoft Windows Mobile, and/or the like may be employed. Any of these operating systems may be embedded within the hardware of the ROP controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the ROP controller to communicate with other entities through a communications network 13. Various communication protocols may be used by the ROP controller as a subcarrier transport mechanism for interaction, such as, but not limited to: multicast, TCP/IP, UDP, unicast, and/or the like.

### Information Server

An information server component 16 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ROP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ROP database 19, operating systems, other program components, user interfaces, Web browsers, and/or the like.

Access to the ROP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ROP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ROP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 17 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 18 is a stored program component that is executed by a CPU. The Web browser may be a hypertext viewing application such as Google's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the ROP equipped nodes. The combined application may be nugatory on systems employing standard Web browsers.

### Mail Server

A mail server component 21 is a stored program component that is executed by a CPU 03. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ROP.

Access to the ROP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 22 is a stored program component that is executed by a CPU 03. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 20 is a stored program component that is executed by a CPU 03, cryptographic processor 26, cryptographic processor interface 27, cryptographic processor device 28, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ROP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the ROP component to engage in secure transactions if so desired. The cryptographic component facilitates the secure accessing of resources on the ROP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ROP Database

The ROP database component 19 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ROP database may be implemented using various standard data-structures, such as an array, hash, (linked) list, struct, structured text file (e.g., XML), table, and/or the like. Such data-structures may be stored in memory and/or in (structured) files. In another alternative, No-SQL databases may be used such as MongoDB and/or the like. In yet another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the ROP database is implemented as a data-structure, the use of the ROP database 19 may be integrated into another component such as the ROP component 35. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 19 includes several tables 19a-h. A Users table 19a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a ROP. A Product table 719b may include fields such as but not limited to: product_id, product_name, product_manufacturer, product_description, product_price, product_quantity, product_discount, and/or the like. A Clients table 19c may include fields such as, but not limited to: client_ID, client_name, client_product, client_price, client_IP, client_account, client_GPS, client_MAC, client_serial, client_ECID, client_UDID, client_browser, client_type, client_model, client_version, client_OS, client_apps_list, client_securekey, and/or the like. A Customer table 19d may include fields such as, but not limited to: customer_id, customer_demographics, customer_zipcode, customer_location, customer_name, customer_past_purchase, customer_income, and/or the like. A Seller table 719e may include fields such as, but not limited to: seller_id, seller_name, seller_address, seller_zipcode, seller_demographics, seller_orgnization_name, seller_sales_performance, and/or the like. A Sale table 719f may include fields such as, but not limited to: sale_id, sale_product_id, sale_price, sale_quantity, sale_revenue, sale_discount, sale_surplus, and/or the like. A Forecast table 719g may include fields such as, but not limited to: Forecast_id, forecast_date, forecast_product_id, forecast_client_id, forecast_segment, forecast_price, forecast_probability, forecast_optimal_price, forecast_optimal_discount. A Market Data table 19h may include fields such as, but not limited to: market_data_feed_ID, asset_ID, asset_symbol, asset_name, spot_price, bid_price, ask_price, competitor_name, competitor_price, competitor_sales_performance, competitor_market_share, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the ROP database may interact with other database systems. For example, employing a distributed database system, queries and data access by search ROP component may treat the combination of the ROP database, an integrated data security layer database as a single database entity.

In one embodiment, user programs may contain various user interface primitives, which may serve to update the ROP. Also, various accounts may require custom database tables depending upon the environments and the types of clients the ROP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 19a-h. The ROP may be configured to keep track of various settings, inputs, and parameters via database controllers.

The ROP database may communicate to and/or with other components in a component collection, including itself, and/or facilities of the like. Most frequently, the ROP database communicates with the ROP component, other program components, and/or the like. The database may contain, retain, and provide information regarding other nodes and data.

### The ROPs

The ROP component 35 is a stored program component that is executed by a CPU. In one embodiment, the ROP component incorporates any and/or all combinations of the aspects of the ROP discussed in the previous figures. As such, the ROP affects accessing, obtaining and the provision of information, services, transactions, and/or the like across various communications networks. The features and embodiments of the ROP discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the ROP's features and facilities, and in many cases reduce the costs, energy consumption/requirements, and extend the life of ROP's underlying infrastructure; this has the added benefit of making the ROP more reliable. Similarly, many of the features and mechanisms are designed to be easier for users to use and access, thereby broadening the audience that may enjoy/employ and exploit the feature sets of the ROP; such ease of use also helps to increase the reliability of the ROP. In addition, the feature sets include heightened security as noted via the Cryptographic components 20, 26, 28 and throughout, making access to the features and data more reliable and secure.

The ROP component may transform via ROP components into, and/or like use of the ROP. In one embodiment, the ROP takes inputs (e.g., 205a-d in FIG. 2; and/or the like) etc., and transforms the inputs via various components (e.g., input data processing component 742, sales forecast component 743, price optimization component 745, consumer clustering component 746, geo-localized price optimization component 747; and/or the like), into outputs (e.g., purchasing prediction results 211 in FIG. 2; and/or the like).

The ROP component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ROP server employs a cryptographic server to encrypt and decrypt communications. The ROP component may communicate to and/or with other components in a component collection, including itself, and/or facilities of the like. Most frequently, the ROP component communicates with the ROP database, operating systems, other program components, and/or the like. The ROP may contain, communicate, generate, obtain, and/or provide program component, system, user, and/or data communications, requests, and/or responses.

### Distributed ROPs

The structure and/or operation of any of the ROP node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ROP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the ROP controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″123.123.123.123″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm.IBMDI.doc/referen

ceguide295.htm

and other parser implementations:

http://publib.boulder.ibm.com/infocenter/tivihelp/v2r1/index.jsp?topic=/com.ibm.IBMDI.doc/referen

ceguide259.htm

all of which are hereby expressly incorporated by reference herein.

In order to address various issues and advance the art, the entirety of this application for REVENUE OPTIMIZATION PLATFORM APPARATUSES, METHODS, SYSTEMS AND SERVICES (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed, alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a ROP individual and/or enterprise user, database configuration and/or relational model, data type, data transmission and/or network framework, syntax structure, and/or the like, various embodiments of the ROP may be implemented that allow a great deal of flexibility and customization. For example, aspects of the ROP may be adapted for product campaign management. While various embodiments and discussions of the ROP have been directed to, however, it is to be understood that the embodiments described herein may be readily configured and/or customized for a wide variety of other applications and/or implementations.

### ROP APIs

The ROP does not mandatorily have to the used through the graphic user interfaces of the ROP. Alternatively, the ROP functionality may be instantiated as a ROP Service and made programmatically available through a number of APIs (Application Programming Interfaces) offered by the ROP, so that the ROP functionality may be programmatically accessed and used by third-party applications, including exemplary applications running on computer systems, mobile devices and/or appliances.

The developer of the third-party application will be able to use the documented functions of the ROP APIs, to send price optimization requests from client applications running on mobile devices or computer systems for proposed product or service and/or client segmentation, the data comprising type, price and/or sales revenues. The APIs will provide the capability of focusing on specific data sets or subsets, for example through analyzing relationships found between the input data, in order to focus on customer segments defined in various ways, including the use of demographic data, geographic data, etc. The API functions will thus allow the provisioning of the selected data subset, on which the sales price optimization and revenue maximization calculations of the ROP methods will be performed.

The ROP APIs will return the results of the computed ROP optimization calculations to the third-party application running on the mobile devices and/or the computer systems of users.

### ROP Service

The ROP Service can provide one or more of the functionalities of the ROP method instantiated on a ROP system, including instantiating a sales prediction component at a user-operated mobile device or computer system; obtaining an input dataset including a user-configured sales price of a product via a user interface of the sales prediction component; processing the obtained input dataset to test quality of the input data; performing price optimization based on an optimization procedure that maximizes a sales revenue; obtaining a suggested price from the revenue optimization; and presenting the obtained suggested price via a graphic user interface of the sales prediction component.

An exemplary embodiment of the ROP Service and/or the ROP System may be instantiated and hosted on a Platform-as-a-Service (PaaS) infrastructure, the PaaS being only one instantiation example on a virtualization environment.

What is claimed is:

1. A revenue optimization processor-implemented method, comprising:
(i) obtaining an input dataset including past sales data;
(ii) analyzing relationships found between sales data, and optionally additional metrics associated with past transactions; and/or customer segments; and/or demographic data; and/or events for executing optimization of the sales price, sales revenue and/or success rate of sales transaction;
(iii) performing price optimization based on an optimization procedure that maximizes a sales revenue;
(iv) in a processor automatically generating probability for successful sales at given prices of products and/or services;
(v) calculating revenue leakage and/or revenue potential on the basis of the calculated optimal price; and
(v) making available the results of revenue optimization to mobile applications and/or computer systems.

2. The method of claim 1, wherein the non-linear optimization procedure maximizes the amount of extra revenue that is gained if the product is sold at a given sales price, further comprising:
instantiating a sales prediction mobile component at a user operated mobile device;
obtaining an input dataset including a user configured sales price of a product via a user interface of the sales prediction mobile component;
processing the obtained input dataset to test quality of the input data;
performing price optimization based on a non-linear optimization procedure that maximizes a sales revenue;
obtaining a suggested price from the non-linear optimization; and
presenting the obtained suggested price via a graphic user interface of the sales prediction mobile component.

3. The method of claim 2, wherein the user-operated mobile device provides at least a minimal data set to a package comprising at least a data server; and wherein the server generates a user record based on the input dataset and optionally, may load additional input product data directly from a merchant and/or the data server.

4. The method of claim 3, wherein the package generates prediction results, and optionally stores user record data including the data input and the prediction results in a data server.

5. The method of claim 4, wherein the testing and processing of the obtained input dataset to test quality of the input data comprises estimating a demand function from won deals, or from both won and lost deals, and performing optimization calculations under different constraints.

6. The method of claim 1, wherein the revenue optimization method is operated by a package comprising at least a data server; and wherein the server stores past and generated data in a database.

7. A computer-implemented revenue optimization system, comprising:
(i) means for acquiring past sales data;
(ii) means for processing input sales data;
(iii) means for performing price optimization based on an optimization procedure that maximizes revenue;
(iv) means for calculating revenue leakage and/or revenue potential on the basis of the calculated optimal price; and
(v) means for supplying the results of price optimization to mobile devices, and/or computer systems.

8. The system according to claim 7, further comprising:
(i) a user-operated mobile device comprising a sales prediction and/or sales revenue optimization mobile component; and
(ii) a user interface operably installed on the user-operated mobile device or computer; the user interface comprising means for entering a dataset, including a user-configured sales price of a product, and means for displaying a second dataset via the user interface including an obtained suggested price, probability of success at the obtained suggested price and the revenue surplus at the obtained suggested price.

9. The system according to claim 7, wherein at least one of the means (i) to (iv) executes a processor-implemented method.

10. The system according to claim 7, comprising a client controller orchestrating the reception, generation, and distribution of data and/or instructions to, from and between one or more client applications and/or one or more servers.

11. The system according to claim 10, wherein the client controller and/or one or more of the other means such as user interface modules are instantiated on a user mobile device, other computers or housed separately from databases and/or other data processing modules within the system.

12. The system according to claim 11, wherein the one or all of the system modules and/or databases are housed within and/or configured as part of the controller.

13. The system according to claim 7, wherein part of the system is hosted in a virtualization environment and wherein the virtualization environment comprises of one or more virtualization hosts, each optionally running as Platform as a Service (PaaS) machine.

14. A computer implemented revenue optimization platform or service comprising:
(i) an Application Programming Interface (API) for receiving price optimization requests from client applications running on mobile devices or computer systems for proposed product or service and/or client segmentation, the data comprising type, price and/or sales revenues;
(ii) means for analyzing relationships found between the input data, and optionally supplying client applications running on mobile devices or computer systems additional metrics associated with past transactions; and/or customer segments; and/or demographic data; and/or events for executing optimization of the sales price and/or sales revenue; and/or probability for successful sales for given prices of products and/or services; and/or optimal sales revenue and/or sales prices; through API component modules, and
(iii) means for providing the computed data to the client application running on the mobile devices and/or computer systems through the API.

15. The service according to claim 14, further providing a general purpose computer system executing logic further comprising:
(i) instantiating a sales prediction component at a user-operated mobile device or computer system;
(ii) obtaining an input dataset including a user-configured sales price of a product via a user interface of the sales prediction component;
(iii) processing the obtained input dataset to test quality of the input data;
(iv) performing price optimization based on an optimization procedure that maximizes a sales revenue;
(v) obtaining a suggested price from the revenue optimization; and
(vi) presenting the obtained suggested price via a graphic user interface of the sales prediction component.

16. The computer system according to claim 14, comprising a storage medium readable by a processing circuit and storing instructions run by the processing circuit for performing the logic.

17. The service according to claim 14, wherein revenue optimization of products or services offered to users further comprises obtaining a suggested price from the optimization procedure; and presenting the obtained suggested price via a graphic user interface from an input dataset including a user-configured sales price of a product via a user interface of the sales prediction component; and processing the obtained input dataset to test quality of the input data; and performing price optimization based on an optimization procedure that maximizes a sales revenue.
